(19) United States
(12) Patent Application Publication
(10) Pub. No.: US 2025/0372804 A1
(43) Pub. Date: Dec. 4, 2025

(54) Thermal Runaway Fumes Management

(71) Applicant: ZEPHYROS, INC., Romeo, MI (US)

(72) Inventors: Frédéric Degoutte, Molsheim Cedex (FR); Amar Ali-Larnene, Molsheim Cedex (FR); Florent Caffy, Molsheim Cedex (FR)

(21) Appl. No.: 18/869,102

(22) PCT Filed: Jun. 21, 2023
(86) PCT No.: PCT/EP2023/066714

§ 371 Date: Nov. 25, 2024

(30) Foreign Application Priority Data
Jun. 24, 2022 (EP) 22181117.7

(51) Int. Cl. H01M 50/358; B60R 16/04; C09J 5/06; C09J 5/08; C09J 7/28; C09J 7/35; H01M 50/30

(52) U.S. Cl. CPC H01M 50/358; B60R 16/04; C09J 5/06; C09J 5/08; C09J 7/28; C09J 7/35; H01M 50/394; C09J 2203/33; C09J 2301/304; C09J 2400/163; H01M 2200/10; H01M 2220/20

(57) ABSTRACT

The invention relates to an assembly for a vehicle protecting the passenger cell against contamination by a gas that is released from a battery module in case of thermal runaway. The released gas propagates into a hollow element of the vehicle providing a passageway which is blocked at a location by an expanded cured adhesive material thus providing a barrier to the gas.

Priority is claimed of European patent application no. 22 181 117.7 that was filed on Jun. 24, 2022.

The invention relates to an assembly for a vehicle protecting the passenger cell against contamination by a gas that is released from a battery module in case of thermal runaway. The released gas propagates into a hollow element of the vehicle providing a passageway which is blocked at a location by an expanded cured adhesive material thus providing a barrier to the gas.

Charged battery cells of vehicles are vulnerable to elevated temperatures because heated cell components can overcome chemical activation energy and decompose in exothermic chemical reactions. In the worst case, if heated to a critical temperature, the unwanted self heating rate of the cell becomes larger than the heat dissipation rate and the cell will transit into the so called “thermal runaway”. In case of charged lithium-ion cells with high energy density, the thermal runaway is a fast, violent, self accelerating chemical reaction of the electrodes and the electrolyte which releases high amounts of heat and gas. The gas may contain e.g. H₂, CO, CH₄, C₂H₄, C₂H₆, C₃H₈, HF, POF₃, PF₅ making it burnable and toxic (J. Sun et al., Nano Energy 27 (2016) 313-319). Battery packs are often fitted inside the available space in the luggage compartment of the vehicle. Then, the only barrier between the passengers of the car and the lithium-ion cells is the casing of the battery pack. The casing must protect the occupants from any gas or heat emission of the lithium-ion cells (A. W. Globukov et al., RSC Adv. 2018, 8, 40172-40186).

Various safety features have been developed for high energy density lithium-ion batteries in order to improve safety with a focus on the avoidance and early detection of thermal runaways. These safety features include cathode material designs, anode modifications, modifications of traditional polyolefin membranes, separators with high thermal stability, functionalized separators, modified electrolytes, alternative lithium salts, functional additives, nonflammable electrolyte systems, and the like (J. Duan et al., Electrochemical Energy Reviews (2020) 3:1-42; X. Feng et al, Joule 4, 743-770, Apr. 15, 2020).

US 2010 0136404 A1 relates to a battery pack that includes one or more thermal barrier elements, the thermal barrier elements dividing the cells within the battery pack into groups of cells. The thermal barrier elements that separate the cells into groups prevent a thermal runaway event initiated in one group of cells from propagating to the cells within a neighboring group of cells.

US 2013 0273400 A1 discloses a battery pack system that includes at least one cell carrier assembly configured to provide electric current during use. The battery pack system further includes a battery pack enclosure for housing the at least one cell carrier assembly. The battery pack enclosure has at least one wall with at least one channel sized to receive an edge of the cell carrier assembly to locate the cell carrier assembly at a location within the battery pack enclosure and provide a thermal pathway during use.

WO 2015 179625 A1 provides lithium ion batteries that include materials that provide advantageous endothermic functionalities contributing to the safety and stability of the batteries. The endothermic materials may include a ceramic matrix incorporating an inorganic gas-generating endothermic material. If the temperature of the lithium ion battery rises above a predetermined level, the endothermic materials serve to provide one or more functions to prevent and/or minimize the potential for thermal runaway, e.g., thermal insulation (particularly at high temperatures); (ii) energy absorption; (iii) venting of gases produced, in whole or in part, from endothermic reaction(s) associated with the endothermic materials, (iv) raising total pressure within the battery structure; (v) removal of absorbed heat from the battery system via venting of gases produced during the endothermic reaction(s) associated with the endothermic materials, and/or (vi) dilution of toxic gases (if present) and their safe expulsion from the battery system.

WO 2016 141467 A1 provides an apparatus, methods and systems for thermal runaway and gas exhaust management for high power batteries. A battery module has a plurality of cell-containing carriers stacked on top of one another to form a cell stack having a front end and a rear end. A duct extends through the cell stack between the front end and the rear end for collecting escaped gases from the battery cells. A self-closing one-way pressure relief valve is located in the duct toward the rear end of the cell stack. The pressure relief valve connects to a piping system for carrying the gases to a remote location where the gases can be safely released and dispersed.

US 2017 0025720 A1 relates to an energy storage unit, in particular a battery module, having a plurality of galvanic cells, in particular of battery cells, wherein the galvanic cells in each case have a first outer side comprising a first electrode and a second outer side comprising a second electrode and the galvanic cells are electrically interconnected with one another by juxtaposition of the galvanic cells by way of the outer sides via the electrodes. Consequently, the invention generally relates to the interconnection of galvanic cells, in particular of battery cells, to form a multi-cell energy store.

US 2017 0155155 A1 relates to a battery electrode assembly which includes a current collector with conduction barrier regions having a conductive state in which electrical conductivity through the conduction barrier region is permitted, and a safety state in which electrical conductivity through the conduction barrier regions is reduced.

US 2019 292427 A1 relates to a structural adhesive formulation, which is heat activatable at a heat activation temperature; meltable without heat activation at an application temperature above its melting point and below the heat activation temperature; and solid at ambient temperature; wherein upon heat activation the structural adhesive formulation is capable of expansion with a volumetric expansion of up to about 250 vol.-%; wherein the heat activatable structural adhesive formulation comprises (a) an epoxy resin component; (b) an adhesion promoter component; (c) a cross-linking component; (d) a blowing component; (e) optionally, an impact modifier component; (f) optionally, a thixotropic filler component; and (g) optionally, a non-thixotropic filler component.

US 2021 0066683 A1 relates to a method to prevent or minimize an occurrence of a thermal runaway event in a battery module of an electric vehicle. The method places a gas barrier between a venting space and a wall of each battery cell so that escaped gas from one battery cell does not impinge onto another battery cell.

US 2021 0351440 A1 provides a wound-type cell and a preparation method thereof, a battery, and an electronic product. The provided features are said to be helpful to reduce safety risks caused by lithium-plating during the fast charging of lithium ion battery.

US 2021 0376405 A1 relates to a composite thermal barrier material for use in electric and hybrid vehicle battery packs. The composite material comprises a porous core layer, a pair of flame retardant layers disposed on either side of the porous core layer, and at least one radiant barrier layer disposed between the porous core layer and one of the pair of flame retardant layers.

US 2022 0069377 A1 relates to a high voltage battery module and a pack, in which a thermal barrier is mounted, and, more particularly, relates to a battery module comprising a cell assembly stacked with a plurality of secondary battery cell; a housing accommodating the cell assembly, a thermal barrier is placed in the housing, wherein the thermal barrier comprises a heat resistant layer to prevent propagation of heat or flame from a secondary battery cell to an neighboring secondary battery cell.

US 2022 0109131 A1 discloses a method including selectively applying a light-cure adhesive to recesses in a first side of a carrier layer and inserting battery cells into respective recesses. The method further includes exposing the first side of the carrier layer to light to at least partially cure the light-cure adhesive with the carrier layer in a first orientation, moving the carrier layer into a second orientation, and exposing a second opposite side of the carrier layer to light to fully cure the light-cure adhesive. The recesses may include a sidewall having crush points spaced apart along the sidewall and a bottom portion having an opening between a pair of crush points, where adhesive is not disposed between the pair of crush points.

US 2022 013758 A1 relates to a vehicular battery pack which includes: a case having an internal space to accommodate a battery cell therein, an inlet to introduce air into the internal space of the case, an outlet to discharge air from the internal space of the case, and an expandable foam member disposed in at least a portion of each of the inlet and the outlet.

US 2022 0158291 A1 relates to a battery module which includes an array of electrochemical cells, and a frame configured to support the cells within the battery module, the fame encircling the array in such a way as to overlie the cell sidewall of each cell and expose the cell first end and the cell second end of each cell.

US 2022 200079 A1 details exemplary traction battery pack venting systems for use in electrified vehicles. An exemplary traction battery pack system may include a venting system having one or more vent ducts for expelling battery vent byproducts from a battery pack. The vent ducts may include a thermal barrier configured to block heat emitted by the battery vent byproducts during cell venting events. In some embodiments, the thermal barrier includes a thermal barrier coating. In other embodiments, the thermal barrier includes both a thermal barrier coating and a thermal barrier layer. In still other embodiments, a second thermal barrier may be applied to vehicle components located near the battery pack for improving the thermal barrier properties.

EP 3 985 784 A1 relates to a battery for an aircraft. The battery may include a battery casing with a casing wall that forms an interior volume, a plurality of battery cells that is arranged in the interior volume, and a functional layer that is arranged at the casing wall between the plurality of battery cells and the battery casing. The functional layer may include an intumescent material that, in case of a breach of the battery casing, is adapted to ensuring flame containment within the interior volume and mitigation of uncontrolled heat and gas emission from the interior volume through the breach of the battery casing.

While safety of high energy density batteries has been improved over the past years making occurrence of thermal runaways less likely, thermal runaway remains a considerable risk that cannot be excluded with absolute certainty.

There is thus a demand for solutions dealing with thermal runaways once they occur. In particular, there is a demand for methods of treating the hazardous gases that are released in the course of thermal runaways in an environmentally friendly manner and without causing harm to the passengers of the vehicle.

It is an object of the invention to provide improved assemblies for vehicles that are capable of capturing the hazardous gases that are released in the course of thermal runaways in an environmentally friendly manner and without causing harm to the passengers of the vehicle.

This object has been achieved by the subject-matter of the patent claims.

It has been surprisingly found that the gases which are released in the course of thermal runaways can be supplied to hollow structures of the vehicle. The gases may be entrapped within the hollow structures and/or guided to locations of the vehicle where they can cool down without entering the passenger cell (passenger cabin) or otherwise causing harm to the passengers of the vehicle.

Further, it has been surprisingly found that expandable curable adhesive materials can be used within the hollow structures of the vehicles which upon expansion and curing block certain passageways within the hollow structures by providing a barrier to the gas. Locating the adhesive materials at the right locations within the hollow structures therefore allows for guiding the gas to propagate along a certain route within the free (unblocked) passageways of the hollow structure.

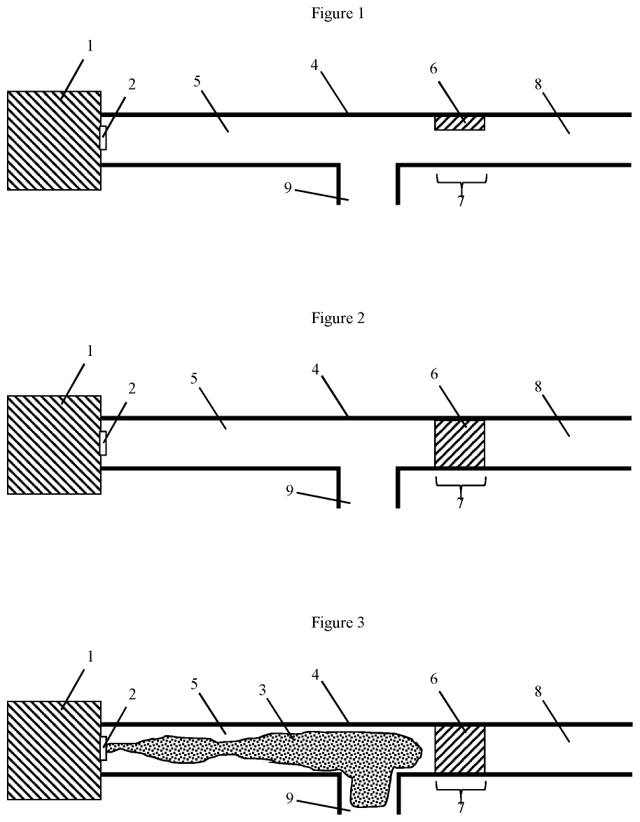

FIGS. 1 to 3 schematically illustrate a preferred embodiment of the assembly according to the invention. FIG. 4 shows an experimental setting.

A first aspect of the invention relates to an assembly for a vehicle, the assembly comprising
a battery module having a gas exhaust port through which in case of a thermal runaway a gas is released from the battery module;
a hollow member defining an optionally branched passageway which is connected in a gas permeable manner to the gas exhaust port such that in case of the thermal runaway the gas which is released from the battery module through the gas exhaust port propagates into the passageway; and
a barrier element which is attached to at least a portion of an interior surface of a wall of the hollow member at a location of the passageway, and which comprises or essentially consists of an expandable curable adhesive material being configured such that after expansion and curing of the adhesive material, the barrier element blocks the passageway at the location and provides a barrier to the gas.

Thus, the expandable curable adhesive material and the barrier element are configured to block the passageway at the location and to provide a barrier to the gas when the adhesive material is activated to expand and cure.

Activation of the adhesive material to expand and cure may take place either during a manufacturing operation of the vehicle as a precautionary measure (permanent block). According to preferred embodiments of the invention, the expandable curable adhesive material is then configured to expand and cure during a manufacturing operation of the vehicle (e.g. in a body-in-white oven and/or during an e-coat operation) such that the manufactured vehicle comprises the material in the expanded and cured state. As a precautionary measure, irrespective of the occurrence of a thermal runaway, in the manufactured vehicle the barrier element permanently blocks the passageway at the location and provides a permanent barrier to the gas, if any. According to these embodiments, the expandable curable adhesive material is configured to expand and cure during a manufacturing operation of the vehicle such that the vehicle after its manufacture comprises the adhesive material in its expanded and cured state and the barrier element permanently blocks the passageway at the location and provides a barrier to the gas.

Alternatively, activation of the adhesive material to expand and cure may take place during operation of the manufactured vehicle (block induced by thermal runaway). According to preferred embodiments of the invention, the expandable curable adhesive material is then configured to expand and cure upon contact with the gas in case of a thermal runaway during operation of the vehicle such that the manufactured vehicle initially comprises the material in the expandable and curable state. In the absence of a thermal runaway, in the manufactured vehicle under regular operation the barrier element does not block the passageway at the location and does not provide a barrier to the gas. Only in case of a thermal runaway when the gas is released from the battery module and propagates through the passageway such that it comes into contact with the barrier element and heats the expandable curable adhesive material, the adhesive material is activated to expand and cure such that it blocks the passageway at the location and provides a barrier to the gas. According to these embodiments, the expandable curable adhesive material is configured to expand and cure during a thermal runaway upon contact with the gas (and heat transfer) such that the vehicle after its manufacture initially comprises the material in its expandable and curable state that is converted into its expanded and cured state in case of a thermal runaway.

The assembly according to the invention can therefore be present in different situations (states, conditions):
in a situation (i) (regular operation), there is regular operation of the battery module without thermal runaway;
in a situation (ii) (irregular operation), there is irregular operation of the battery module, namely thermal runaway releasing a gas from the battery module through the gas exhaust port so that the gas propagates into the passageway.

In both situations, the adhesive material may be initially present either (a) in its expanded and cured state (permanent block), or (b) in its expandable curable state (block induced by thermal runaway).

When the adhesive material is initially already present (a) in its expanded and cured state (permanent block),
under regular operation (situation (i)) the barrier element permanently blocks the passageway at the location and provides a permanent barrier; and
under irregular operation (situation (ii)) in case of a thermal runaway the gas that is released from the battery module propagates into the passageway but cannot pass the barrier element because the adhesive material is already present in its expanded and cured state such that it permanently blocks the passageway. Under these circumstances, the thermal runaway does not change the state of the adhesive material because it was already previously expanded and cured, namely during a manufacturing operation of the vehicle.

When the adhesive material is initially present (b) in its expandable curable state (block induced by thermal runaway),
under regular operation (situation (i)) the barrier element does not block the passageway at the location and does not provide a barrier; and
under irregular operation (situation (ii)) in case of a thermal runaway the gas that is released from the battery module propagates into the passageway and induces expansion and curing of the adhesive material upon contact. Initially, when the propagating gas has not yet reached the expandable curable material and has not yet heated the expandable curable material to its activation temperature (i.e. expansion activation temperature and curing activation temperature), the adhesive material is still expandable and curable, i.e. has still not undergone expansion or curing, and the passageway is unblocked at the location such that it does not provide a barrier to the gas. After a certain while, however, after the propagating gas has reached the expandable curable material and has heated the expandable curable material to its activation temperature (i.e. expansion activation temperature and curing activation temperature), expansion and curing of the adhesive material is induced by the heat transfer. The originally expandable curable material is then converted into an expanded and cured material, and the passageway is blocked at the location such that it provides a barrier to the gas. The gas cannot pass the barrier element because the adhesive material is then present in its expanded and cured state such that it blocks the passageway. Under these circumstances, the thermal runaway changes the state of the adhesive material; while it was initially present in its expandable curable state (i.e. not already previously expanded and cured during a manufacturing operation of the vehicle), it is activated as a consequence of the thermal runaway and converted into its expanded cured state.

It has been found that expanding and curing the adhesive material during a manufacturing operation of the vehicle (permanent block) has advantages. The thus achieved permanent block does not require any heat transfer from the gas to the adhesive material. The block is already in place when the gas reaches the location of the passageway. Thus, the block hinders any gas to pass from the very beginning of the thermal runaway. In contrast, inducing expansion and curing the adhesive material in case of a thermal runaway (block induced by thermal runaway) requires some time until the activation temperature of the expandable curable adhesive material has been reached (i.e. expansion activation temperature and curing activation temperature). During this time, a first portion of the gas may pass along the barrier element, as the barrier element develops its blocking effect with a certain delay.

For the purpose of the specification, a “thermal runaway” is any event where in consequence of a failure of a battery module a heated gas is inadvertently generated and released from the battery module.

The battery module has a gas exhaust port for releasing a gas from the battery module in case of a thermal runaway. Thus, the gas exhaust port can be present in different situations (states, conditions):
in a situation (i) (regular operation), there is regular operation of the battery module without thermal runaway. Under these circumstances, no gas is released from the battery module;
in a situation (ii) (irregular operation), there is irregular operation of the battery module, namely thermal runaway, and gas is released from the battery module through the gas exhaust port so that the gas propagates into the passageway.

In analogy, all other elements of the assembly according to the invention may be present in different situations (i) and (ii), which hereinafter are not individualized for each and every element.

The gas exhaust port is preferably an integral part of the battery module and located at a position where in case of a thermal runaway heated gas is collected so that it can be released from the battery module in a controlled manner. The gas exhaust port may be equipped with a vent such that the heated gas needs to be under a predetermined pressure within the battery module before it is released through the gas exhaust port.

The hollow member of the vehicle has walls that define a passageway which may optionally be branched. For example, the hollow member may be part of a frame of the vehicle wherein the walls of the frame define the passageway through which that gas may propagate. The passageway is connected in a gas permeable manner to the gas exhaust port such that in case of the thermal runaway the gas which is released from the battery module through the gas exhaust port propagates into the passageway. Suitable connectors are known to the skilled person and comprise but are not limited to fittings, pipe unions, and the like. Typically, the passageway is connected to the gas exhaust port in a firm manner such that no gas can escape into the environment. Thus, typically the entire amount of the gas that is released from the battery module through the gas exhaust port enters the passageway. The thus released gas then propagates through the passageway, either due to diffusion or by active transport e.g. by means of a vent.

The barrier element comprises or essentially consists of an expandable curable adhesive material. Besides the adhesive material, the barrier element may comprise a carrier. The adhesive material exists in two different states. In its initial state, the adhesive material is in its green state and is expandable and curable upon activation by a suitable stimulus, preferably elevated temperature. Alternative stimuli are also contemplated such as actinic radiation, humidity, and the like. In its activated state, the material is cured (thermoset, hardened) and expanded (e.g. foamed).

Expandable curable materials that exists in an initial state and that can be activated to provide an expanded cured state are principally known to the skilled person and commercially available. As the expandable curable adhesive material is heated, it expands, cross-links, and structurally bonds to adjacent surfaces. An example of a preferred formulation is an epoxy-based material that is commercially available from L&L Products, Inc. of Romeo, Mich., under the designations that include L-5204, L-5207, L-5214, L-5234, L-5235, L-5236, L-5237, L-5244, L-5505, L-5510, L-5520, L-5540, L-5573 or combinations thereof. Such materials may exhibit properties including relatively high strength and stiffness, promote adhesion, rigidity, and impart other valuable physical and chemical characteristics and properties.

Preferably, the adhesive material upon activation provides good adhesion to metal with good resistance to corrosion. Further, the adhesive material is preferably compatible by e-coat technology, i.e. resists wash-off when being exposed to bathing and rinsing steps that are typically applied in the course of e-coat technology. Further, the expansion activation temperature and the curing activation temperature of the adhesive material are preferably adjusted such that at the temperatures in an e-coat oven expansion and curing of the adhesive material are activated.

The barrier element is attached to at least a portion of an interior surface of a wall of the hollow member at a location of the passageway. The barrier element may be attached to said surface through the intrinsic adhesion of the adhesive material itself. Alternatively, the barrier element may be equipped with means for attaching it to the surface. Suitable means comprise but are not limited to mechanical fasteners, pressure sensitive adhesives, and the like.

The location where within the passageway the barrier element is attached to the interior surface of the wall of the hollow element can be freely chosen. It is also contemplated that the passageway comprises more than one barrier element at different locations. The more than one barrier elements may then have identical design, composition and size or independently of one another different design, composition and/or size. The location where within the passageway the barrier element is attached to the interior surface of the wall of the hollow element is preferably selected in the proximity of a branching point of the passageway, i.e. where the passageway is split into a first branch and a second branch. Preferably, the barrier element is attached to the interior surface of the wall of the hollow element at a location of a branch of the passageway that would otherwise be connected to the passenger cell of the vehicle in a gas permeable manner. Thus, when the barrier element after expansion (i.e. volume expansion, foaming) and curing (i.e. hardening, cross-linking) blocks the branch of the passageway at such location, it provides a barrier to the gas and the gas cannot further propagate through the branch of the passageway thereby prevention contamination of the passenger cell by the gas through this branch of the passageway.

The present invention thus allows for guiding the gas that is released from the battery module in case of a thermal runaway to a location of the vehicle where it can be controlled, typically towards the rear of the car, so that no gases can enter the passenger cell.

In preferred embodiments of the assembly according to the invention, the adhesive material prior to expansion and curing is dry and non-tacky to the touch at 23° C. For the purpose of the specification, an adhesive material is considered to be non-tacky to the touch if it does not need a force more than 2 N to pull out a 25 mm diameter stainless steel plate applied on its surface.

In preferred embodiments of the assembly according to the invention, the adhesive material after expansion and curing has a volume that is at least 50 vol.-%, preferably at least 100 vol.-%, more preferably at least 150 vol.-% greater than its volume prior to expansion and curing. In preferred embodiments, volume expansion is within the range of from 150 to 250 vol.-% compared to the volume prior to expansion and curing. In further preferred embodiments of the assembly according to the invention, the adhesive material after expansion and curing has a volume that is at least 250 vol.-%, preferably at least 500 vol.-%, more preferably at least 1000 vol.-% greater than its volume prior to expansion and curing. In preferred embodiments, volume expansion is within the range of from 250 to 2500 vol.-% compared to the volume prior to expansion and curing.

In preferred embodiments of the assembly according to the invention, the adhesive material after expansion and curing (i.e. the expanded cured adhesive material) forms a layer or sheet having a thickness of at least 1 mm, preferably at least 2 mm, more preferably at least 3 mm.

In preferred embodiments of the assembly according to the invention, the adhesive material after expansion and curing (i.e. the expanded cured adhesive material) forms a layer or sheet having a thickness of at most 6 mm, preferably at most 5 mm, more preferably at most 4 mm.

In preferred embodiments of the assembly according to the invention, the adhesive material has an expansion activation temperature within the range of from 100 to 200° C., preferably 140 to 180° C., more preferably about 160° C. In further preferred embodiments of the assembly according to the invention, the adhesive material has an expansion activation temperature within the range of from 10 to 30° C. such that it is expandable at room temperature.

In preferred embodiments of the assembly according to the invention, the adhesive material has a curing activation temperature within the range of from 100 to 200° C., preferably 140 to 180° C., more preferably about 160° C. In further preferred embodiments of the assembly according to the invention, the adhesive material has an curing activation temperature within the range of from 10 to 30° C. such that it is curable at room temperature.

When the expansion activation temperature and/or the curing activation temperature are within the range of from 10 to 30° C., the expandable curable adhesive material is preferably based upon a two-component system, which starts expansion and curing spontaneously when the two components of the two-component system are mixed with one another, e.g. at room temperature. As expansion and curing takes some time, the adhesive material in its expanding and curing state (open time) may then be attached to at least a portion of an interior surface of a wall of the hollow member at a location of the passageway where continued expansion and curing will then block the passageway until expansion and curing have come to an end and the adhesive material is thermoset (cured, hardened). Alternatively, the two-components may be mixed with one another in the course of applying the adhesive material to at least a portion of an interior surface of a wall of the hollow member at a location of the passageway, e.g. by means of an applicator equipped with a cartridge having two separate chambers for the two components of the two-component systems and that has an application outlet where the two components are mixed with one another immediately before they exit the applicator.

The expandable curable adhesive material may be provided as a film or layer. The thickness of the film or layer is not particularly limited. A skilled person recognizes that the amount of expandable curable adhesive material that needs to be localized within the passageway in order to block the passageway after expansion and curing the adhesive material depends upon the dimensions of the passageway, particularly its cross-section and diameter, respectively, as well as the volume expansion of the adhesive material. The degree of volume expansion depends upon the type and amount of blowing agent contained in the adhesive material and can be determined by routine tests.

Preferably, the adhesive material comprises
(a) one or more monomers, prepolymers or polymers comprising reactive functional groups that are capable of undergoing curing reaction;
(b) a curing agent for (a), typically capable of undergoing curing reaction with or inducing curing reaction of the reactive functional groups of the one or more monomers, prepolymers or polymers (a);
(c) optionally, a curing agent activator;
(d) a blowing agent;
(e) optionally, a blowing agent activator;
(f) optionally, one or more additional polymers; preferably wherein said one or more additional polymers do not comprise said reactive functional groups of above one or more monomers, prepolymers or polymers (a);
(g) optionally, a toughening agent;
(h) optionally, one or more fillers; and
(i) optionally, one or more flame retardants and/or smoke suppressors.

The one or more monomers, prepolymers or polymers comprising reactive functional groups that are capable of undergoing curing reaction can be based upon different chemistry, preferably epoxy chemistry, urethane chemistry, acrylate chemistry, or mixtures thereof.

The curing agent capable of undergoing curing reaction with or inducing curing reaction of the reactive functional groups of the one or more monomers, prepolymers or polymers (a) can analogously be based upon different chemistry, preferably curing agents for epoxy resins, urethane resins, acrylate resins, or mixtures thereof.

The a curing agent activator can likewise be based upon different chemistry, depending upon the chemical nature of the monomers, prepolymers or polymers (a) and the respective curing agent.

The one or more additional polymers, which preferably do not comprise said reactive functional groups of above one or more monomers, prepolymers, or polymers (a), can likewise be based upon different chemistry, depending upon the chemical nature of the monomers, prepolymers or polymers (a).

Expandable curable adhesive materials that are based upon epoxy chemistry, urethane chemistry, or acrylate chemistry are known to the skilled person. In this regard, reference is made to the following documents, all incorporated herein by reference: US 2003 0018095, US 2004 0082673, US 2004 0204551, US 2004 0224108, US 2005 0022929, US 2005 0043420, US 2007 0207284, US 2007 0281523, US 2010 0028651, US 2010 0183863, US 2010 0280167, US 2013 0020832, US 2015 0198051, 2015 0266518, US 2015 0352930, US 2015 0367893, US 2016 0122539, US 2016 0201708, US 2019 0144718, US 2019 0292427, US 2020 0216722 and US 2021 0380852.

The blowing agent can be a chemical blowing agent or a physical blowing agent.

Preferably, the blowing agent is a chemical blowing agent; preferably selected from the group consisting of azodicarbonamide, dinitrosopentamethylenetetramine, 4,4′-oxy-bis-(benzenesulfonylhydrazide), trihydrazinotriazine and N,N′-dimethyl-N,N′-dinitrosoterephthalamide; more preferably azodicarbonamide.

It is also contemplated that the blowing agent is a physical blowing agent, e.g. expandable microspheres. Suitable expandable microspheres are commercially available (e.g. Expancel®).

Preferably, the blowing agent activator is zinc oxide. 1 to 10 wt.-% based on the weight of the adhesive material may typically be contained.

Preferably, the toughening agent is an ethylene methylacrylate copolymer.

Preferably, the toughening agent is an epoxy/elastomer adduct; preferably wherein the epoxy is a diglycidyl ethers of bisphenol (DGEB) and wherein the elastomer is selected from the group consisting of carboxyl-terminated butadiene acrylonitrile rubber (CTBN), carboxyl terminated polybutadiene (CTPB), hydroxyl-terminated butadiene acrylonitrile rubber (HTBN), hydroxyl-terminated polybutadiene (HTPB), amine terminated butadiene acrylonitrile rubber (ATBN), epoxidized hydroxyl-terminated polybutadiene (EHTPB), and mixtures thereof; more preferably wherein the epoxy is a diglycidyl ether of bisphenol A (DGBEA) or a diglycidyl ethers of bisphenol F (DGBEF), and wherein the elastomer is a carboxyl-terminated butadiene acrylonitrile rubber (CTBN). Other toughening agents are known to the skilled person and are also contemplated.

Mixtures of two or more toughening agents are also contemplated.

Preferably, the total content of the one or more toughening agents is within the range of 25±20 wt.-%, preferably 25±15 wt.-%, more preferably 25±10 wt.-%, still more preferably 25±5 wt.-%, in each case relative to the total weight of the adhesive material.

Preferably, the one or more fillers comprise or essentially consist of calcium oxide, magnesium oxide, calcium carbonate, magnesium carbonate, talc, wollastonite, bentonite, kaolin, mica, powdered quartz, fumed silica, silica aerogel, coal tar, carbon black, glass particles, textile fibers, glass fibers, aramid fibers, aramid pulp, boron fibers, carbon fibers, and mixtures thereof.

Preferably, the total content of the one or more fillers is within the range of 30±25 wt.-%, preferably 30±20 wt.-%, more preferably 30±15 wt.-%, still more preferably 30±10 wt.-%, yet more preferably 30±5 wt.-%, in each case relative to the total weight of the adhesive material.

Preferably, the one or more flame retardants and/or smoke suppressors are selected from
(i) halogen-containing flame retardants and/or smoke suppressors; e.g. bromine compounds, chlorine compounds, or halogenated phosphates;
(ii) inorganic flame retardants and/or smoke suppressors; e.g. metal hydroxides, metal oxides, siliconcontaining additives, ammonium polyphosphate, red phosphorous, expandable graphite;
(iii) organic phosphorous/nitrogen flame retardants and/or smoke suppressors; e.g. aliphatic phosphates, aliphatic phosphonates, aromatic phosphonates; and
(iv) inherent flame-retardant and/or smoke suppressor systems.

For details, reference is made to e.g. L. Chen et al., Polym. Adv. Technol. 2010, 21, 1-26.

In preferred embodiments, the adhesive material is based upon epoxy chemistry and comprises
(a) one or more polymers comprising reactive epoxy functional groups (curable epoxy resin);
(b) a curing agent for (a); preferably a latent curing agent for (a);
(c) optionally, a curing agent activator; and
(f) optionally, one or more polymers not comprising reactive epoxy functional groups.

Preferably, the one or more polymers comprising reactive epoxy functional groups comprise or essentially consist of one or more solid epoxy resins, one or more liquid epoxy resins, one or more glycidyl (meth)acrylate copolymers, one or more glycidyl (meth)acrylate terpolymers, or mixtures thereof.

Preferably, the one or more solid epoxy resins and/or the one or more liquid epoxy resins independently of one another are diglycidyl ethers of bisphenol (DGEB), preferably diglycidyl ethers of bisphenol A (DGBEA) and/or diglycidyl ethers of bisphenol F (DGBEF).

Preferably, the total content of the one or more polymers comprising reactive epoxy functional groups is within the range of 30±25 wt.-%, preferably 30±20 wt.-%, more preferably 30±15 wt.-%, still more preferably 30±10 wt.-%, yet more preferably 30±5 wt.-%, in each case relative to the total weight of the adhesive material.

Preferably, the latent curing agent is selected from the group consisting of aliphatic amines, cycloaliphatic amines, aromatic amines, modified polyamines, unmodified polyamines, modified polyamides, unmodified polyamides, blocked amines, amidoamines, anhydrides, polycarboxylic polyesters, isocyanates, phenol-based resins, phenol novolak resins, cresol novolak resins, copolymers of phenol terpene, polyvinyl phenol, bisphenol-A formaldehyde copolymers, bishydroxyphenyl alkanes, hydrazides, sulphones, diamino diphenyl sulphone, or mixtures thereof; preferably a guanidine; more preferably selected from the group consisting of dicyandiamide (cyanoguanidine), methylguanidine, dimethylguanidine, trimethylguanidine, tetramethylguanidine, methylisobiguanidine, dimethylisobiguanidine, tetramethylisobiguanidine, hexamethylisobiguanidine, heptamethylisobiguanidine, and mixtures thereof; still more preferably dicyandiamide.

Preferably, the curing agent activator is selected from the group consisting of modified urea (substituted urea) or unmodified urea, imidazoles and mixtures thereof; preferably methylene diphenyl bis urea.

Preferably, the one or more polymers not comprising reactive epoxy functional groups comprise or essentially consist of one or more ethylene (meth)acrylate copolymers, one or more ethylene vinylacetate copolymers, and mixtures thereof.

Preferably, the total content of the one or more polymers not comprising reactive epoxy functional groups is within the range of 5.0±4.5 wt.-%, relative to the total weight of the adhesive material.

In other preferred embodiments, the adhesive material is based upon acrylate chemistry and comprises
(a) one or more monomers or prepolymers comprising ethylenically unsaturated functional groups, typically acrylic groups, or polyolefin based copolymers;
(b) a curing agent for (a);
(c) optionally, a curing agent activator;
(d) a blowing agent; and
(f) optionally, one or more polymers not comprising ethylenically unsaturated functional groups.

Suitable monomers or prepolymers comprising ethylenically unsaturated functional groups are known to the skilled person and comprise but are not limited to (meth)acrylic acids, C₁₋₆-alkyl (meth)acrylates, hydroxy-C₁₋₆-alkyl (meth)acrylate, cycloalkyl (meth)acrylates, and mixtures thereof.

Multifunctional monomers such as dipentaerythritol pentaacrylate may promote crosslinking.

Curing agents compatible with acrylate chemistry are known to the skilled person and comprise but are not limited to curatives such as N,N-dimethyl-para-toluidine (DMPT), N-(2-hydroxyethyl)-N-methyl-para-toluidine (MHPT), N-methyl-N-(2-hydroxypropyl)-p-toluidine (2HPMT), and N-ethyl-N-(2-hydroxyethyl)-p-toluidine (EHPT); more preferably N-methyl-para toluidine derivatives, N-(2-hydroxyethyl)-N-methyl-para-toluidine, N-ethyl-N-(2-hydroxyethyl)-p-toluidine, or any combination thereof.

Polymerization initiators such as peroxides may induce curing.

In further preferred embodiments, the adhesive material is based upon urethane chemistry and comprises
(a) one or more monomers, prepolymers or polymers comprising isocyanate and/or hydroxyl functional groups;
(b) a curing agent for (a);
(c) optionally, a curing agent activator;
(d) a blowing agent; and
(f) optionally, one or more polymers not comprising isocyanate and/or hydroxyl functional groups.

Suitable monomers, prepolymers or polymers comprising isocyanate and/or hydroxyl functional groups are known to the skilled person.

Curing agents compatible with urethane chemistry are known to the skilled person.

The adhesive material according to the invention may contain additional additives and auxiliary substances that are conventionally used in adhesive materials for vehicles, such as impact modifiers, tackifiers, thermoplastics, phenoxy resins, reactive diluents, and the like.

In particularly preferred embodiments, the adhesive material according to the invention comprises the following ingredients at the following content (embodiments A1 to A6):

| | A1 | A2 | A3 | A4 | A5 | A6 |
|---|---|---|---|---|---|---|
| curable polymer(s) | 45.0 ± 40.0 | 45.0 ± 35.0 | 45.0 ± 30.0 | 45.0 ± 25.0 | 45.0 ± 20.0 | 45.0 ± 15.0 |
| curing agent(s) | 2.5 ± 2.4 | 2.5 ± 2.3 | 2.5 ± 2.2 | 2.5 ± 2.1 | 2.5 ± 2.0 | 2.5 ± 1.9 |
| blowing agent(s) | 2.5 ± 2.4 | 2.5 ± 2.3 | 2.5 ± 2.2 | 2.5 ± 2.1 | 2.5 ± 2.0 | 2.5 ± 1.9 |
| optionally, toughener(s) | 25.0 ± 24.0 | 25.0 ± 21.0 | 25.0 ± 18.0 | 25.0 ± 15.0 | 25.0 ± 12.0 | 25.0 ± 9.0 |
| optionally, filler(s) | 25.0 ± 24.0 | 25.0 ± 21.0 | 25.0 ± 18.0 | 25.0 ± 15.0 | 25.0 ± 12.0 | 25.0 ± 9.0 |

In particularly preferred embodiments, the adhesive material according to the invention comprises the following ingredients at the following content (embodiments B1 to B6):

| | B1 | B2 | B3 | B4 | B5 | B6 |
|---|---|---|---|---|---|---|
| solid diglycidyl ether | 45.0 ± 40.0 | 45.0 ± 35.0 | 45.0 ± 30.0 | 45.0 ± 25.0 | 45.0 ± 20.0 | 45.0 ± 15.0 |
| of bisphenol A | | | | | | |
| dicyandiamide and/or | 2.5 ± 2.4 | 2.5 ± 2.3 | 2.5 ± 2.2 | 2.5 ± 2.1 | 2.5 ± 2.0 | 2.5 ± 1.9 |
| substituted urea | | | | | | |
| azodicarbonamide | 2.5 ± 2.4 | 2.5 ± 2.3 | 2.5 ± 2.2 | 2.5 ± 2.1 | 2.5 ± 2.0 | 2.5 ± 1.9 |
| optionally, ethylene | 25.0 ± 24.0 | 25.0 ± 21.0 | 25.0 ± 18.0 | 25.0 ± 15.0 | 25.0 ± 12.0 | 25.0 ± 9.0 |
| methylacrylate copolymer | | | | | | |
| and/or (CTBN)- | | | | | | |
| epoxy adduct | | | | | | |
| optionally, talc and/or | 25.0 ± 24.0 | 25.0 ± 21.0 | 25.0 ± 18.0 | 25.0 ± 15.0 | 25.0 ± 12.0 | 25.0 ± 9.0 |
| calcium oxide | | | | | | |

In preferred embodiments of the assembly according to the invention, after expansion and curing of the adhesive material, the barrier element blocks the passageway at location for at least 5 minutes, preferably for at least 10 minutes, preferably at least 15 minutes, more preferably at least 20 minutes, still more preferably at least 25 minutes, yet more preferably at least 30 minutes, in each case when being exposed to a temperature of 300° C.

Preferably, the adhesive material has a thermal degradation onset temperature of at least 250° C., preferably at least 300° C., preferably at least 310° C., more preferably at least 320° C., still more preferably at least 330° C., yet more preferably at least 340° C., most preferably at least 350° C. Preferably, the thermal degradation onset temperature is determined by thermogravimetry (TGA) analysis, preferably in accordance with ASTM E2550.

In preferred embodiments of the assembly according to the invention, the barrier element comprises a carrier.

Preferably, the carrier comprises a polymer selected from the group consisting of
(i) polyamides (PA);
(ii) polybenzimidazoles (PBI);
(iii) polydicyclopentadiene (pDCPD);
(iv) fluorinated polyolefins, preferably polytetrafluorethylene (PTFE), polyvinylidene difluoride (PVDF);
(v) poly acrylic acids (PAA);
(vi) polyimides (PI), preferably polyetherimides (PEI), polyamide imides (PAI);
(vii) polysulfones (PSU), preferably polyether sulfones (PES), polyphenlysulfones (PPSU);
(viii) polyphenylene sulfides (PPS); and
(ix) polyarylether ketones, preferably polyether ketones (PEK), polyether ether ketones (PEEK).

Preferably, the carrier comprises a metal.

When the barrier element comprises the adhesive material and a carrier, the adhesive material may form a layer on the carrier on either side or both sides of the carrier. Alternatively, the adhesive material may be located along one or more edges of the carrier. A skilled person recognizes that various geometries of carrier and adhesive material are possible in order to ensure that upon activation, i.e. expansion and curing, the barrier element blocks the passageway at the location where it is attached to the inner wall of the hollow member. The carrier may be planar (i.e. have a flat form) or have a three-dimensional shape. The circumference of the carrier may resemble the circumference of the passageway at the location where the barrier element is attached to the inner wall of the hollow member.

In preferred embodiments of the assembly according to the invention, the hollow member comprises or essentially consists of a structural member; preferably a frame of the vehicle or a part thereof; more preferably selected from the group consisting of pillars, rocker panels, floorpan, roof, inner aprons, quarter panels, and combinations thereof.

In preferred embodiments of the assembly according to the invention, the passageway is a branched duct system comprising a first branch and a second branch.

Preferably, after expansion and curing of the adhesive material, the barrier element blocks the first branch of the passageway at the location and provides a barrier to the gas such that in case of a thermal runaway the gas cannot pass the first branch of the passageway at the location and is guided to the second branch of the passageway, which preferably is not blocked (i.e. unblocked) so that in case of a thermal runaway the gas can escape through said second branch.

Preferably, prior to expansion and curing of the adhesive material, the first branch of the passageway is connected in a gas permeable manner to a passenger cell of the vehicle.

Preferably, the second branch of the passageway is not connected in a gas permeable manner to a passenger cell of the vehicle. Preferably, the second branch is not blocked (i.e. unblocked) so that in case of a thermal runaway the gas can escape through said second branch. Preferably, the second branch is not blocked with a barrier element.

In particularly preferred embodiments, the passageway is a branched duct system comprising a first branch and a second branch; wherein prior to expansion and curing of the adhesive material (either during a manufacturing operation of the vehicle or in case of a thermal runaway), the first branch of the passageway is connected in a gas permeable manner to a passenger cell of the vehicle; wherein the second branch of the passageway is not connected in a gas permeable manner to a passenger cell of the vehicle; and wherein the assembly is configured such that after expansion and curing of the adhesive material (either during a manufacturing operation of the vehicle or in case of a thermal runaway), the barrier element blocks the first branch of the passageway at the location and provides a barrier to the gas such that in case of a thermal runaway the gas cannot pass the first branch of the passageway at the location and is guided to the second branch of the passageway which is not blocked by a barrier element.

In preferred embodiments, the second branch is connected in a gas permeable manner to the outside of the vehicle such that in case of a thermal runaway the gas can escape from the passageway through the second branch.

In other preferred embodiments, the second branch is not connected in a gas permeable manner to the outside of the vehicle such that the gas is entrapped within the hollow structures, e.g. in the second branch of the passageway.

The battery module is not particularly limited and typically comprises a plurality of cells that are mounted in the housing. The gas exhaust port is then preferably located at the housing.

In preferred embodiments of the assembly according to the invention, the battery module is equipped with a vent which in case of the thermal runaway enhances release of the gas from the battery module through the gas exhaust port and propagation into the passageway.

In preferred embodiments of the assembly according to the invention, the vehicle is selected from automotive vehicles, transportation vehicles, and railway vehicles.

In preferred embodiments of the assembly according to the invention, the adhesive material has been expanded and cured and wherein the barrier element blocks the passageway at a location.

Another aspect of the invention relates to a method for preparing an assembly for a vehicle according to the invention as described above, the method comprising the steps of
(A) providing a battery module having a gas exhaust port through which in case of a thermal runaway a gas is released;
(B) providing a hollow member defining an optionally branched passageway which is connected in a gas permeable manner to the gas exhaust port such that in case of the thermal runaway the gas which is released from the battery module through the gas exhaust port propagates into the passageway;
(C) providing a barrier element which comprises or essentially consists of an expandable curable adhesive material;
(D) attaching the barrier element to at least a portion of an interior surface of a wall of the hollow member at a location of the passageway; and
(E) optionally, expanding and curing the adhesive material such that the barrier element blocks the passageway at the location and provides a barrier to the gas.

In preferred embodiments of the method according to the invention, step (E) involves heating the adhesive material to a temperature that is above its expansion activation temperature and above its curing activation temperature. Preferably, step (E) is performed in a body-in-white oven and/or during an e-coat operation.

However, it is also contemplated that the expandable curable adhesive material remains in its expandable curable state, i.e. is not yet activated e.g. in a body-in-white oven and/or during an e-coat operation. As the gas that is released from a battery module in case of a thermal runaway has a considerable temperature itself (e.g. 300° C. and more), it may be sufficient to use the heating effect by the gas that propagates through the passageway in order to activate, i.e. expand and cure the adhesive material thereby blocking the passageway at the desired location.

Another aspect of the invention relates to the use of a barrier element according to the invention as described above for providing a barrier to a gas, in an optionally branched passageway; preferably in an assembly for a vehicle according to the invention as described above; wherein the gas is released in case of a thermal runaway from a battery module through an gas exhaust port and propagates into the passageway.

Another aspect of the invention relates to the use of a barrier element according to the invention as described above for guiding a gas in an optionally branched passageway; preferably in an assembly for a vehicle according to the invention as described above; wherein the gas is released in case of a thermal runaway from a battery module through an gas exhaust port and propagates into the passageway.

Another aspect of the invention relates to the use of a barrier element according to the invention as described above for protecting a passenger cell of a vehicle against a gas; in an optionally branched passageway; preferably in an assembly for a vehicle according to the invention as described above; wherein the gas is released in case of a thermal runaway from a battery module through an gas exhaust port and propagates into the passageway.

The invention is further illustrated by the preferred embodiment that is schematically illustrated in FIGS. 1 to 3, which however are not to be construed as limiting the scope of the invention.

FIG. 1 schematically illustrates the assembly with the adhesive material in its expandable curable state (green state), i.e. prior to activation. A battery module (1) having a gas exhaust port (2) through which in case of a thermal runaway a gas (3) is released is connected in a gas permeable manner to a hollow member (4) defining an optionally branched passageway (5) such that in case of the thermal runaway the gas (3) which is released from the battery module (1) through the gas exhaust port (2) propagates into the passageway (5). A barrier element (6) comprising or essentially consisting of the expandable curable adhesive material is attached to at least a portion of an interior surface of a wall of the hollow member (4) at a location of the passageway (5) comprising a first branch (8) and a second branch (9).

FIG. 2 relates to the same embodiment as FIG. 1, but schematically illustrates the assembly with the adhesive material in its expanded cured state, i.e. after activation. The barrier element (6) blocks the passageway (5) at the location (7).

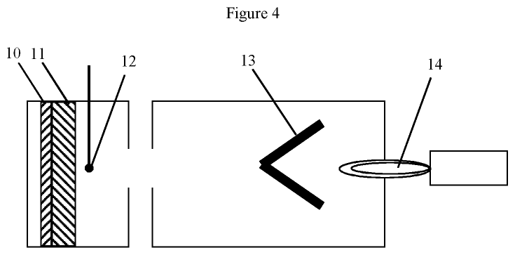

FIG. 3 relates to the same embodiment as FIG. 2, but schematically illustrates the assembly in case of a thermal runaway. The gas (3) is released from the battery module (1) through the gas exhaust port (3) and propagates into the passageway (5). Due to the expanded cured state of the adhesive material, the barrier element (6) blocks the first branch (8) of the passageway (5) thereby providing a barrier to the gas (3). The gas (3) propagates in the passageway (5) and is guided to the second branch (9) of the passage way (5) which is unblocked.

FIG. 4 schematically illustrates an experimental setting for testing the performance of a barrier element under laboratory conditions. A barrier element of carrier (10) and expanded cured adhesive material (11) on one of its two surfaces is placed in a chamber. A temperature sensor (12) is arranged in front of the expanded cured adhesive material (11). Heat is generated by a flame (14) and deflected by heat deflector (13). The heat can dissipate from the flame (14) around the heat deflector (13) and enter the chamber containing the barrier element and the temperature sensor (12). The expanded cured adhesive material (11) can be subjected to a certain temperature under controlled experimental conditions and its structural integrity can be evaluated over time.

Reference numerals:

| | |
|---|---|
| (1) | battery module |
| (2) | gas exhaust port |
| (3) | gas |
| (4) | hollow member |
| (5) | passageway |
| (6) | barrier element |
| (7) | location |
| (8) | first branch |
| (9) | second branch |
| (10) | carrier |
| (11) | expanded cured adhesive material |
| (12) | temperature sensor |
| (13) | heat deflector |
| (14) | flame |

The following examples further illustrate the invention but are not to be construed as limiting its scope.

A barrier element was prepared by providing a polyamide carrier and applying an expandable curable adhesive material to one of its surfaces. The curable adhesive material contained the following ingredients in the following amounts:

| | | amount [wt.-%] | |
|---|---|---|---|
| function | ingredient | sample 1 | sample 2 |
| curable | solid diglycidyl ether of | 45.00 | |
| polymer | bisphenol A | | |
| | polyolefin based copolymer | | 60.00 |
| curing agent | dicyandiamide | 2.00 | |
| | substituted urea | 0.50 | |
| | dipentaerythritol pentaacrylate | | 0.55 |
| | peroxide | | 2.00 |
| blowing | azodicarbonamide | 2.50 | 10.00 |
| agent | | | |
| blowing | zinc oxide | | 5.00 |
| agent | | | |
| activator | | | |
| toughener | ethylene methylacrylate copolymer | 10.00 | |
| | carboxyl terminated butadiene | 15.00 | |
| | acrylonitrile rubber (CTBN)-epoxy | | |
| | adduct | | |
| filler | talc | 20.00 | |
| | calcium oxide | 5.00 | |
| | calcium carbonate | | 12.45 |
| tackifier | petroleum hydrocarbon resin | | 10.00 |

| | | |
|---|---|---|
| total | 100.00 | 100.00 |

Two different barrier elements were tested for barrier performance. They were subjected to elevated temperature (165° C. for 30 min) in order to cause expansion and curing like in a body in white oven. The expanded cured adhesive material layer (foam) of sample 1 had an average thickness of 5 mm, sample 2 had an average thickness of 15 mm.

Thermal resistance was investigated under various conditions in accordance with FIG. 4 and the results are compiled in the table here below:

| temperature | time of exposure | sample 1 | sample 2 |
|---|---|---|---|
| 250° C. | 5 min | passed | passed |
| | 10 min | passed | passed |
| 300° C. | 5 min | passed | failed |
| | 10 min | passed | failed |
| 600° C. | 5 min | passed | failed |

1. An assembly for a vehicle, the assembly comprising
a battery module having a gas exhaust port through which in case of a thermal runaway a gas is released;
a hollow member defining a passageway which is connected in a gas permeable manner to the gas exhaust port such that in case of the thermal runaway the gas which is released from the battery module through the gas exhaust port propagates into the passageway; and
a barrier element which is attached to at least a portion of an interior surface of a wall of the hollow member at a location of the passageway, and which comprises or essentially consists of an expandable curable adhesive material being configured such that after expansion and curing of the adhesive material, the barrier element blocks the passageway at the location and provides a barrier to the gas.

2. The assembly according to claim 1, wherein the expandable curable adhesive material is configured to expand and cure during a manufacturing operation of the vehicle such that the vehicle after its manufacture comprises the adhesive material in its expanded and cured state and the barrier element permanently blocks the passageway at the location and provides a barrier to the gas.

3. The assembly according to claim 1, wherein the expandable curable adhesive material is configured to expand and cure during a thermal runaway upon contact with the gas such that the vehicle after its manufacture initially comprises the material in its expandable and curable state that is converted into its expanded and cured state in case of a thermal runaway.

4. The assembly according to claim 1, wherein the passageway is branched.

5. (canceled)

6. The assembly according to claim 1, wherein the adhesive material after expansion and curing has a volume that is at least 50 vol.-%.

7-8. (canceled)

9. The assembly according to claim 1, wherein the adhesive material has an expansion activation temperature within the range of from 100 to 200° C.

10. The assembly according to claim 1, wherein the adhesive material has a curing activation temperature within the range of from 100 to 200° C.

11. The assembly according to claim 9, wherein the adhesive material comprises
(a) one or more monomers, prepolymers or polymers comprising reactive functional groups that are capable of undergoing curing reaction;
(b) a curing agent for (a); and
(d) a blowing agent.

12-36. (canceled)

37. The assembly according to claim 11, wherein the barrier element comprises a carrier and the carrier comprises a metal.

38. The assembly according to claims, wherein the hollow member comprises or essentially consists of a vehicle structural member.

39. The assembly according to claim 38, wherein the structural member is a frame of the vehicle or a part thereof; preferably selected from the group consisting of pillars, rocker panels, floorpan, roof, inner aprons, quarter panels, and combinations thereof.

40. The assembly according to claim 1, wherein the passageway is a branched duct system comprising a first branch and a second branch.

41. The assembly according to claim 40, which is configured such that after expansion and curing of the adhesive material, the barrier element blocks the first branch of the passageway at the location and provides a barrier to the gas such that in case of a thermal runaway the gas cannot pass the first branch of the passageway at the location and is guided to the second branch of the passageway.

42. The assembly according to claim 41, which is configured such that prior to expansion and curing of the adhesive material, the first branch of the passageway is connected in a gas permeable manner to a passenger cell of the vehicle.

43. The assembly according to claim 42, wherein the second branch of the passageway is not connected in a gas permeable manner to a passenger cell of the vehicle.

44. The assembly according to claim 43, wherein the second branch of the passageway is unblocked.

45. (canceled)

46. The assembly according to claim 1, wherein the passageway is a branched duct system comprising a first branch and a second branch; wherein prior to expansion and curing of the adhesive material, the first branch of the passageway is connected in a gas permeable manner to a passenger cell of the vehicle; wherein the second branch of the passageway is not connected in a gas permeable manner to a passenger cell of the vehicle; and wherein the assembly is configured such that after expansion and curing of the adhesive material, the barrier element blocks the first branch of the passageway at the location and provides a barrier to the gas such that in case of a thermal runaway the gas cannot pass the first branch of the passageway at the location and is guided to the second branch of the passageway which is not blocked by a barrier element.

47-50. (canceled)

51. A method for preparing an assembly for a vehicle according to claims, the method comprising the steps of
(A) providing a battery module (1) having a gas exhaust port (2) through which in case of a thermal runaway a gas (3) is released;
(B) providing a hollow member (4) defining an optionally branched passageway (5) which is connected in a gas permeable manner to the gas exhaust port (2) such that in case of the thermal runaway the gas (3) which is released from the battery module (1) through the gas exhaust port (2) propagates into the passageway (5);
(C) providing a barrier element (6) which comprises or essentially consists of an expandable curable adhesive material;
(D) attaching the barrier element (6) to at least a portion of an interior surface of a wall of the hollow member (4) at a location (7) of the passageway (5); and
(E) optionally, expanding and curing the adhesive material such that the barrier element (6) blocks the passageway (5) at the location (7) and provides a barrier to the gas (3).

52. The method according to claim 51, wherein step (E) involves heating the adhesive material to a temperature that is above its expansion activation temperature and above its curing activation temperature.

53. The method according to claim 51, wherein step (E) is performed in a body-in-white oven and/or during an e-coat operation.

54-56. (canceled)
